(19) United States
(12) Patent Application Publication
(10) Pub. No.: US 2019/0327403 A1
(43) Pub. Date: Oct. 24, 2019

(54) SHOOTING DEVICE AND SHOOTING METHOD

(71) Applicant: AVISION INC., Hsinchu (TW)

(72) Inventors: Yu-Lang WANG, Hsinchu County (TW); Chun-Chieh LIAO, Hsinchu City (TW)

(21) Appl. No.: 16/278,774

(22) Filed: Feb. 19, 2019

(30) Foreign Application Priority Data
Apr. 24, 2018 (TW) 107113921

(51) Int. Cl. H04N 5/235

(52) U.S. Cl. CPC H04N 5/2351; H04N 5/2353

(57) ABSTRACT

A shooting device including a camera lens and a controller is provided. The camera lens is configured to shoot a picture. The controller, electronically coupled to the camera lens, divides the picture into a plurality of initial blocks each corresponding to an initial brightness value, selects at least one selection block from the initial blocks, and calculates an average brightness value according to the initial brightness value corresponding to the at least one selection block.

This application claims the benefit of Taiwan application Serial No. 107113921, filed Apr. 24, 2018, the subject matter of which is incorporated herein by reference.

### BACKGROUND OF THE INVENTION

### Field of the Invention

The invention relates in general to a shooting device and a shooting method, and more particularly to a shooting device and a shooting method capable of adjusting the brightness of a shot image.

### Description of the Related Art

An ordinary camera module adjusts the brightness of a shot image by dividing a picture image into 25 blocks, and determines the exposure time according to the sum of the brightness values of the 25 blocks. When an ordinary camera module shoots an object, the picture includes the object and its background. When the color of the background changes, the brightness of the to-be-shot object may become too bright or too dark.

Therefore, it has become a prominent task for the industries to provide a method capable of suitably adjusting the brightness of the image when shooting an object.

### SUMMARY OF THE INVENTION

To resolve the above problems, a shooting device including a camera lens and a controller is provided in an embodiment of the present invention. The camera lens is configured to shoot a picture. The controller, electronically coupled to the camera lens, divides the picture into a plurality of initial blocks each corresponding to an initial brightness value, selects at least one selection block from the initial blocks, and calculates an average brightness value according to the initial brightness value corresponding to the at least one selection block.

To resolve the above problems, a shooting method is provided in another embodiment of the present invention. The shooting method includes the following steps: shooting a picture; dividing the picture into a plurality of initial blocks each corresponding to an initial brightness value; selecting at least one selection block from the initial blocks; and calculating an average brightness value according to the initial brightness value corresponding to the at least one selection block.

To summarize, according to the shooting device and the shooting method of the present invention, the shot picture is divided into a to-be-shot region and a background region, only some picture blocks are selected, an average brightness value is calculated according to the selected picture blocks, and the exposure time is determined according to the average brightness value corresponding to at least one block of the to-be-shot region. For example, when the average exposure value is over a threshold (such as 100), the exposure time is reduced; otherwise the exposure time is increased. Therefore, no matter the background region is bright or dark, the image of the to-be-shot region (such as the document 300) is clear and the brightness of the to-be-shot object is not affected by the background.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of a shooting system;

FIG. 2 is a flowchart of a shooting method; and

FIG. 3 is a schematic diagram of a picture.

### DETAILED DESCRIPTION OF THE INVENTION

Detailed descriptions of the embodiments of the invention are made with reference to accompanying drawings. The embodiments are not for limiting the scope of protection of the invention. The descriptions of the structure and operations are not for limiting the order of execution, and any equivalent devices formed by the structures formed of different arrangements of the elements are within the scope of protection of the invention. Moreover, the dimension scales used in the accompanying drawings are not based on actual proportion of the product. Designations common to the accompanying drawings are used to indicate identical or similar elements.

Moreover, ordinal numbers, such as “the first”, “the second”, and etc., are used in the specification and claims to differentiate the elements or operations described using the same terminologies, not to designate specific sequence or order or limit the invention.

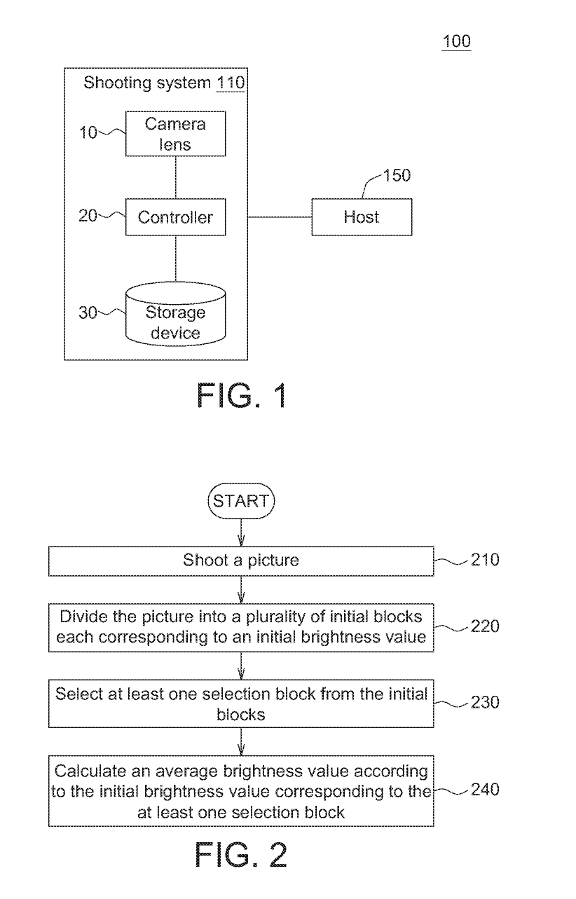

Refer to FIGS. 1 and 2. FIG. 1 is a schematic diagram of a shooting system 100. FIG. 2 is a flowchart of a shooting method 200. As indicated in FIG. 1, the shooting system 100 includes a shooting device 110. In an embodiment, the shooting system 100 further includes a host 150, which can be realized by a computer, a mobile phone, a server, or other electronic device with computation and transmission functions.

In an embodiment, the shooting device 110 includes a camera lens 10 and a controller 20. The camera lens 10 is electronically coupled to the controller 20. In an embodiment, the camera lens 10 can be realized by a charge coupled device (CCD) or a complementary metal-oxide semiconductor (CMOS); the controller 20 can be realized by a microcontroller, a microprocessor, a digital signal processor, an application specific integrated circuit (ASIC) or a logic circuit.

In an embodiment, the shooting device 110 further includes a storage device 30 configured to store the image shot by the camera lens 10. The storage device 30 is electronically coupled to the controller 20. In an embodiment, the storage device 30 can be realized by a flash memory, a floppy disk, a hard drive, a disc, a flash drive, a tape, or any storage medium with similar function that can be easily related by those who are skilled in the art.

The shooting method 200 is disclosed below. The hardware used in the shooting method 200 can be realized by the elements of FIG. 1. In an embodiment, after the controller 20 of the shooting device 110 receives a triggering signal from the host 150, the controller 20 controls (or activates) the camera lens 10 to shoot a picture and proceeds to step 210. The host 150 can execute an application to transmit the triggering signal.

In step 210, a picture PIC is shot by the camera lens 10.

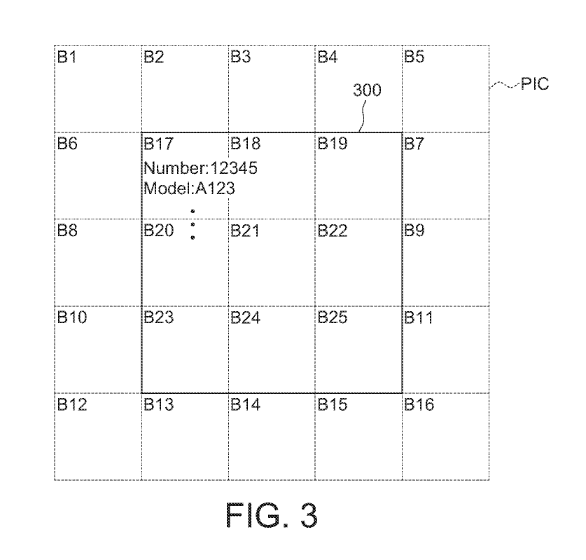

In an embodiment, as indicated in FIG. 3 being a schematic diagram of a picture PIC, in which a document 300, horizontally placed on a desktop, is shot by the camera lens 10 from an overlooking angle.

However, in the present invention, the to-be-shot object (such as the document 300) does not have to be placed on the desktop in a horizontal manner, and any manner would do as long as the to-be-shot object can be shot by the camera lens 10.

In step 220, the picture PIC is divided into a plurality of initial blocks B1-B25 by the controller 20, wherein each of the initial blocks B1-B25 corresponds to an initial brightness value.

As indicated in FIG. 3, the picture PIC is divided into 25 (5×5) initial blocks B1-B25 by the controller 20. In an embodiment, the initial blocks B1-B25 can further be divided into a to-be-shot region composed of the initial blocks B17-B25 and a background region composed of the initial blocks B1-B16. To be more specifically, the picture PIC further includes a background region (such as partial desktop) composed of the initial blocks B1-B16 in addition to the to-be-shot region composed of the initial blocks B17-B25 occupied by the document 300.

In an embodiment, the initial blocks B1-B25 can have identical or different dimensions.

In step 230, at least one selection block is selected from the initial blocks B1-B25 by the controller 20.

In an embodiment, the at least one selection block is arranged as a cross. For example, the controller 20 selects the initial blocks B3, B18, B21, B24, B14, B8, B20, B22, and B9 of the picture in FIG. 3. In general, the initial blocks B3, B18, B21, B24, B14, B8, B20, B22, and B9 are arranged as a cross.

In an embodiment, at least one selection block can be the central 9 blocks B1-B25 of the initial blocks. For example, the controller 20 selects the initial blocks B17-B19, B20-B22, B23-B25 in FIG. 3. In general, the initial blocks B17-619, B20-B22, B23-B25 are the central 9 blocks of the picture PIC.

In an embodiment, the at least one selection block is the centermost block B21 of the initial blocks B1-B25.

In step 240, an average brightness value is calculated by the controller 20 according to the initial brightness value corresponding to the at least one selection block.

In an embodiment, when the controller 20 selects the initial blocks B3, B18, B21, B24, B14, B8, B20, B22, B9 in FIG. 3 (arranged as a cross), the controller 20 obtains respective initial brightness values corresponding to the initial blocks B3, B18, B21, B24, B14, B8, B20, B22, and B9 of the picture PIC, and then calculates an average brightness value by dividing the sum of the initial brightness values by the number of the initial brightness values.

In an embodiment, when the controller 20 selects the initial blocks B17-B25 (the central 9 blocks) in FIG. 3, the controller 20 obtains respective initial brightness values corresponding to the initial blocks B17-B25 of the picture PIC, and then calculates an average brightness value by dividing the sum of the initial brightness values by the number of the initial brightness values.

In an embodiment, when the controller 20 selects the centermost initial block B21 among the initial blocks B1-B25 in FIG. 3, the controller 20 obtains the initial brightness value corresponding to the initial block B21 of the picture PIC, and regards the initial brightness value as the average brightness value.

Normally, the shooting device needs to adjust the brightness of the entire picture to a suitable level. Therefore, when determining the exposure time, the shooting device needs to consider the sum of the brightness values of the 25 blocks of the entire picture. However, when shooting a target object (such as the document 300) in a special shooting scenario, only the to-be-shot region composed of the blocks B17-B25 occupied by the document 300 is the real focus, and the background region (such as partial desktop) composed of the blocks B1-B16 does not need to be considered. Anyone skilled in the art will understand that the picture does not have to be divided into 25 blocks. The picture can be divided into 36 blocks, 49 blocks, 100 blocks or other number of blocks.

As disclosed above, when shooting a document 300 (or other object), the document 300 can be placed at the center of the picture PIC, and the background is located at the edges of the picture PIC. To avoid the brightness of the document 300 being affected by the color of the background, the picture is divided into 25 blocks, and the blocks in the background region are better excluded as much as possible when determining the initial brightness values corresponding to the 25 blocks which affect the exposure time. For example, the weight of the initial brightness values corresponding to the initial blocks in the background region is reduced to 0%, and only the initial brightness values corresponding to the central blocks B17-B25 of the document 300 are considered.

To summarize, according to the shooting device and the shooting method of the present invention, the shot picture is divided into a to-be-shot region and a background region, only some picture blocks are selected, an average brightness value is calculated according to the selected picture blocks, and the exposure time is determined according to the average brightness value corresponding to at least one block of the to-be-shot region. For example, when the average exposure value is over a threshold (such as 100), the exposure time is reduced; otherwise the exposure time is increased. Therefore, no matter the background region is bright or dark, the image of the to-be-shot region (such as the document 300) is clear and the brightness of the to-be-shot object is not affected by the background.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A shooting device, comprising:
a camera lens configured to shoot a picture; and
a controller electronically coupled to the camera lens, wherein the controller divides the picture into a plurality of initial blocks each corresponding to an initial brightness value, selects at least one selection block from the initial blocks, and calculates an average brightness value according to the initial brightness value corresponding to the at least one selection block.

2. The shooting device according to claim 1, wherein the controller receives a triggering signal from a host and controls the camera lens to shoot the picture.

3. The shooting device according to claim 1, wherein the at least one selection block is arranged as a cross.

4. The shooting device according to claim 1, wherein the at least one selection block is the central 9 blocks of the initial blocks.

5. The shooting device according to claim 1, wherein the at least one selection block is the centermost block of the initial blocks.

6. A shooting method, comprising:
shooting a picture;
dividing the picture into a plurality of initial blocks each corresponding to an initial brightness value;
selecting at least one selection block from the initial blocks; and
calculating an average brightness value according to the initial brightness value corresponding to the at least one selection block.

7. The shooting method according to claim 6, further comprising:
shooting the picture after receiving a triggering signal.

8. The shooting method according to claim 6, wherein the at least one selection block is arranged as a cross.

9. The shooting method according to claim 6, wherein the at least one selection block is the central 9 blocks of the initial blocks.

10. The shooting device according to claim 6, wherein the at least one selection block is the centermost block of the initial blocks.
